(19) United States
(12) Patent Application Publication
(10) Pub. No.: US 2026/0091769 A1
(43) Pub. Date: Apr. 2, 2026

(54) BRAKE SYSTEM AND METHOD FOR CONTROLLING A BRAKE SYSTEM

(71) Applicant: ZF CV Systems Global GmbH, Bern (CH)

(72) Inventors: Robert Otremba, Ronnenberg (DE); Jan Cohrs, Hannover (DE); Peter Beier, Wunstorf (DE); Christoph Moritz, Hannover (DE); Julian Van Thiel, Grossburgwedel (DE)

(21) Appl. No.: 19/112,729

(22) PCT Filed: Sep. 8, 2023
(86) PCT No.: PCT/EP2023/074757

§ 371 Date: Mar. 18, 2025

(30) Foreign Application Priority Data
Sep. 19, 2022 (DE) 10 2022 123 896.2

(51) Int. Cl. B60T 17/22; B60T 13/74

(52) U.S. Cl. CPC B60T 17/22; B60T 13/74; B60T 2270/402; B60T 2270/414

(57) ABSTRACT

A brake system includes an electromechanical brake module (11.1, 11.2), a first energy storage unit (15), an operating supply circuit (100) for connecting the first energy storage unit (15) to the brake module (11.1, 11.2), a second energy storage unit (25, 25.1) connected to a redundancy supply circuit (200, 200.1), and a control module (16.1, 16.2) connected to the operating supply circuit (100) and the redundancy supply circuit (200, 200.1). The control module (16.1, 16.2) switches from a first switching state, in which the first energy storage unit (15) supplies energy via the operating supply circuit (100), to a second switching state, in which the energy supply is provided via the second energy storage unit (25, 25.1) and the redundancy supply circuit (200, 200.1) in the event of an operating-state fault.

### FIELD

The present disclosure relates to a brake system for a vehicle, in particular for a commercial vehicle, having an electromechanical brake module that is configured to provide a service-brake function and a parking-brake function, a first energy storage unit that is configured to supply energy to the brake module, and an electric operating supply circuit that is connected to the first energy storage unit and is configured to selectively connect the first energy storage unit to the brake module.

### BACKGROUND

Brake systems of the type described above are widely known. Their importance and use in vehicles, in particular commercial vehicles, is steadily increasing in the course of increasing electrification. The advantage of electromechanical brake systems is that they are actuated electrically rather than pneumatically. This has advantages over pneumatic systems, inter alia in respect of installation technology.

Such brake systems include at least one electromechanical brake module, by which a service-brake function and a parking-brake function are provided on at least one wheel axle. Brake modules in this case include, in particular, electromechanical brake actuators that have a locking mechanism for locking the brake actuator. The locking of the brake actuator provides a parking-brake function. This parking-brake function reliably prevents a parked vehicle from rolling away. No energy supply is required in this case to maintain the parking-brake function. However, locking of the brake actuator to provide the parking-brake function may only be performed at a wheel rotational speed close to zero. The service-brake function, which is usually provided in an electromechanical brake module by an electromechanical brake actuator, is therefore also required for the secure parking of a vehicle. Actuating the electromechanical brake actuator requires a constant energy supply, which is provided by the first energy storage unit and the electrical operating supply circuit. The electrical operating supply circuit connects the brake module to the first energy storage unit. A prerequisite for the secure use of electromechanical brake systems is therefore always a fail-safe energy supply for the brake module.

A fault in the energy supply for the brake module occurs when there is a fault in the operating state of the first energy storage unit and the electrical operating supply circuit. An operating-state fault denotes a state in which the voltage provided for the energy supply deviates from a setpoint voltage. If such an operating-state fault occurs, for example due to a short-circuit or damage to a supply lead of the electrical operating supply circuit, an energy supply for the brake module is no longer assured. As a result, the vehicle may not be decelerated by the service-brake function and the locking mechanism may not lock the brake actuator. A fault, or failure, of the energy supply due to a fault in the operating state of both the first energy storage unit and the operating supply circuit therefore poses a potential risk to the operation of an electromechanical brake system.

Known from WO 2021/122214 A1 is an electromechanical brake system in which, in the event of a failure of the energy storage unit of the brake modules of a wheel axle, their energy supply is taken over by a redundant second energy storage unit. This redundant second energy storage unit may be, for example, the energy storage unit of the brake modules of a second wheel axle. The connection between the second redundant energy storage unit and the brake modules of the first wheel axle is still provided via the operating supply circuit of the first wheel axle. Moreover, a fault in the operating state of the operating supply circuit of the first wheel axle is not taken into consideration, or such a fault is not detected. If there is a fault in the operating state of the operating supply circuit of the first wheel axle, therefore, a service-brake function and a parking-brake function may no longer be maintained.

### SUMMARY

The present disclosure is therefore based on the object of overcoming at least one of the disadvantages known from the prior art. In particular, the present disclosure is based on the object of further improving the reliability of an electromechanical brake system of the type mentioned at the outset, and maintaining its functionality in the event of a fault in the operating state of both the first operating supply circuit and the first energy storage unit. The functionality in this case is to be maintained at least to the extent that the vehicle can be decelerated to such an extent that secure parking of the vehicle is made possible by provision of the parking-brake function.

The present disclosure proposes, in the case of a brake system of the type described at the outset, that the brake system include a second energy storage unit and an electrical redundancy supply circuit that is connected to the second energy storage unit. The brake system according to the present disclosure also includes a control module that is connected to the operating supply circuit and the redundancy supply circuit, and that is configured to switch from a first switching state, in which the first energy storage unit supplies energy to the brake module via the operating supply circuit, to a second switching state, in which the second energy storage unit supplies energy to the brake module via the redundancy supply circuit. The control module is also configured to monitor the operating state of the operating supply circuit and of the first energy storage unit in the first switching state, and to switch to the second switching state in the event of an operating-state fault. The control module thus controls the energy supply, and may also be referred to as an energy control module.

The present disclosure is based on the knowledge that there may be a fault in the operating state of the first energy storage unit as well as a fault in the operating state of the first operating supply circuit. For this reason, the present disclosure provides a control module that is configured to monitor the operating state of both the operating supply circuit and the first energy storage unit in a first switching state. By way of this monitoring, the control module recognizes a fault in the operating state of the first energy storage unit, or of the operating supply circuit, and is also configured to switch to a second operating state as a result. In this second operating state, the control module ensures that an energy supply is maintained via a redundancy supply circuit and a second energy storage unit that is connected to the redundancy supply circuit. Damage to the first operating supply circuit therefore no longer results in a failure of the brake actuator.

Insofar as, in the context of the present disclosure, reference is made above and in the following to an energy storage unit, this is to be understood in each case to refer to electrical energy storage units. Insofar as reference is also made to a supply circuit, this is to be understood to refer to an electric circuit including electrical leads and possibly further components such as transistors, capacitors, resistors, and relays, which together form a closed system that performs a task, in this case the supplying of energy.

In the context of the present disclosure, an operating-state fault refers both to a failure of the energy supply due to damage to the operating supply circuit, or the first energy storage unit, and to voltage fluctuations in the energy supply. Such an operating-state fault may be caused, for example, by a short-circuit or the breaking-off of, or damage to, supply leads of the operating supply circuit.

According to a preferred embodiment, the control module is configured, in the first switching state, to monitor in a dedicated manner the operating state of the first energy storage unit and of the operating supply circuit. The control module is thus configured to distinguish between a fault in the operating state of the first energy storage unit and a fault in the operating state of the operating supply circuit. This is advantageous with regard to repair and servicing work.

According to a further preferred embodiment, the first energy storage unit has a monitoring function such that the energy storage unit is configured to communicate a fault in the operating sequence to the control module by the provision of a corresponding fault signal, or the absence of an operating signal. The provision of the fault signal, or a querying of the status of the operating signal is provided, for example, continuously or cyclically.

The first switching state thus relates to a normal operating state in which energy is supplied to the brake module in a fault-free manner via the first energy storage unit and the operating supply circuit. The second switching state relates to an emergency operating state in which, as a result of a fault in the first energy storage unit, or in the operating supply circuit, energy is supplied to the brake module by a second energy storage unit and a redundancy supply circuit. The second energy storage unit is configured to supply the brake module with at least a sufficient quantity of energy to decelerate a vehicle by providing a service-brake function and then providing a parking-brake function.

Preferably, the control module is also configured to electrically decouple the operating supply circuit from the brake module in the event of an operating-state fault. The operating-state fault may concern both a dedicated monitored fault in the operating state of the first energy storage unit, or of the operating supply circuit, and a fault in the jointly monitored operating state of the first energy storage unit and of the operating supply circuit. The electrical decoupling of the operating supply circuit from the brake module protects the brake module from damage. The electrical decoupling of the operating supply circuit from the brake module also at the same time electrically decouples the first energy storage unit from the brake module. In this way, for example, overvoltage of the brake module caused by a defective energy storage unit may be avoided.

According to a preferred embodiment, the control module is realized as a dedicated control module with respect to the brake module, and is arranged at a distance from the brake module. The control module may thus be arranged at a suitable position within the brake system to provide the function of monitoring the operating supply circuit and of the first energy storage unit. Such a control module may also act together with a plurality of brake modules of an electric brake system in such a way that a control module, by switching to the second switching state, connects a plurality of brake modules to the redundancy supply circuit and the second energy storage unit. As a result of the control module being realized as a dedicated control module, it may be arranged, for example, between two brake modules. There is thus no delay in the signal lead between the two brake modules.

Preferably, the control module is arranged close to the brake module. By being arranged close to the brake module, the distance that a corresponding control signal has to travel from the control module to the brake module is reduced. Due to the close arrangement of the control module, the control connection between the control module and the brake module is less susceptible to interference. This is partly due to the fact that cable runs can be shorter.

According to an alternative preferred embodiment, the control module is integrated structurally and/or in respect of control into the brake module. If the control module is structurally integrated into the brake module, the control module is arranged, for example, in the housing of the brake module. Structural and/or control integration of the control module into the brake module enables lead runs to be laid inside the housing, between the control module and the brake module. These are therefore better protected against damage. In the case of a control connection between the control module and brake module, the speed of signal transmission and processing is optimized. In this case, the control module is preferably equipped with an overvoltage protector in order to be protected against short-circuits in the operating supply circuit of the brake module.

Preferably, the control module has a switch-over unit that is configured to switch between the first switching state and the second switching state. It is further preferred that the control module also have a monitoring unit that is configured to monitor the operating supply circuit. This division of functions within the control module, into a switch-over function and a monitoring function, increases the flexibility of the control module. The flexibility of the control module is in this case increased to the extent that the switch-over unit may be arranged, structurally and/or in respect of control, at a distance from the monitoring unit. The units of the control module may thus be integrated into the brake system as required and in a structurally optimized manner with regard to the routing of supply circuits and control circuits.

According to a preferred embodiment, the brake module is a first brake module, and the brake system also comprises a second brake module. In this case, the switch-over unit is preferably a first switch-over unit that is arranged close to the first brake module, and the control module also comprises a second switch-over unit, which is arranged close to the second brake module. Two dedicated switch-over units, each arranged close to one of the two brake modules, reduce the effect of damage to the operating supply circuit. The overall fail-safety of the brake system is thus further increased.

According to a preferred embodiment, the brake module, in particular the first brake module and the second brake module, has/have a brake actuator for providing a braking function. The brake actuator preferably includes a locking mechanism for locking the brake actuator. The control module is preferably configured to connect the brake actuator, or the two brake actuators, in the second switching state, to the redundancy supply circuit, and preferably to decouple them electrically from the operating supply circuit. In this way, a redundant energy supply is provided directly for the brake actuator by the second energy storage unit, and a redundant connection of the brake actuator to the second energy storage unit is provided by the redundancy operating supply circuit. The elimination of further interposed assemblies makes the brake module more compact overall. As a result of the redundant energy supply and energy lead being provided directly on the brake actuator, failures of the service-brake function due to faults in interposed components are also prevented.

According to a further preferred embodiment, the brake module, in particular the first brake module and the second brake module, includes a first brake actuator, which is configured to provide a service-brake function in the first switching state, and a redundant brake actuator, which is configured to provide a service-brake function in the second switching state. The redundant brake actuator is assigned to the redundancy supply circuit and is preferably electrically decoupled from the operating supply circuit. The two brake actuators may be, for example, first windings and second windings of a coil of an electric motor, with the first windings being connected to the operating supply circuit, and the second windings being connected to the redundancy supply circuit. If the first brake actuator is damaged as a result of a fault in the operating state of the first energy storage unit and of the operating supply circuit, the service-brake function is maintained by the redundant second brake actuator.

The redundant brake actuator is assigned to the redundancy supply circuit and is preferably electrically decoupled from the operating supply circuit. The second brake actuator is thus protected from damage, for instance due to overvoltage in the event of a fault in the operating state of the first energy storage unit. Moreover, preferably, at least one of the brake actuators includes a locking mechanism for locking the first brake actuator and/or the redundant brake actuator. Particularly preferably, the locking mechanism is configured to lock the first brake actuator and the second brake actuator. In this way, a parking-brake function is also maintained in the second operating state.

According to a further preferred embodiment, the operating supply circuit is a rear-axle operating supply circuit, and the brake module is a rear-axle brake module. In this embodiment, the brake system also preferably includes a front axle having at least one front-axle brake module, wherein the redundancy supply circuit is a front-axle operating supply circuit assigned to the front axle. The front-axle operating supply circuit is configured to connect the second energy storage unit to the front-axle brake module. Thus, in the second switching state, energy is supplied to both the front-axle brake module and the rear-axle brake module by the second energy storage unit and the connected redundancy supply circuit, or front-axle operating supply circuit. It is to be understood that the redundancy supply circuit is configured both to supply energy to the front-axle brake actuator in the second switching state and to continuously supply energy to the front-axle brake module. The redundancy supply circuit has a corresponding number of supply leads for this purpose. Using the front-axle operating supply circuit as a redundancy supply circuit and the second energy storage unit as a redundant energy storage unit enables the brake system to be made more compact overall. In particular, there may be no need for an additional energy storage unit and an additional redundancy supply circuit in addition to the front-axle operating supply circuit and the rear-axle operating supply circuit.

It is further preferred that the brake system also include an electrical control unit for controlling the brake module, in particular the first brake module and the second brake module. In this case, the operating supply circuit is configured to supply energy to the control unit in the first switching state. Thus, a fault in the operating supply circuit, or the first energy storage unit, results at the same time in a fault in the energy supply to the electrical control unit. The monitoring of the operating supply circuit and of the first energy storage unit thus simultaneously serves to monitor a sufficient energy supply to the electrical control unit.

The control unit is preferably configured to monitor the operating state of the first energy storage unit and of the operating supply circuit in the first switching state and, in the event of an operating-state fault, to communicate an operating-state fault to the control module. This is performed, for example, by the provision of a corresponding fault signal, or in the absence of an operating signal, which is provided, for example, continuously or cyclically. Preferably, the control unit has an emergency power supply for this purpose, in particular its own energy store.

It is further preferred that the operating supply circuit have a dedicated supply lead that is configured to connect the first energy storage unit to the first control unit. The control module is also preferably configured to monitor the operating state of the dedicated supply lead in the first switching state. For example, such monitoring may be performed indirectly via monitoring, or communication with the control unit. Energy is thus supplied to the control unit thus via a separate supply lead. A fault in a supply lead for supplying the brake module therefore does not simultaneously cause a fault in the energy supply of the control unit. Moreover, because of the dedicated supply lead, the control unit may also be arranged flexibly in the brake system, thereby enabling available installation space can be utilized efficiently.

It is further preferred that the brake system include a second electrical control unit, for controlling the front-axle brake module, which is also configured to control the rear-axle brake module in the second switching state. If a first rear-axle brake module and a second rear-axle brake module are assigned to the rear axle, the second electrical control unit is configured to control both the first rear-axle brake module and the second rear-axle brake module in the second switching state. A fault in the operating state of the operating supply circuit, or of the first energy storage unit, may result in impairment of, or damage to, the first electrical control unit connected to the first operating supply circuit. In the second switching state, reliable control of the rear-axle brake module can still be provided by the second electrical control unit.

According to a further preferred embodiment, the rear-axle operating supply circuit also realizes a second redundancy supply circuit for the at least one front-axle brake module of the front axle. A redundant energy supply is thus provided for the front-axle brake modules even in the event of a fault in the front-axle operating supply circuit, or of the second energy storage unit. The fail-safety of the brake system is thus further increased. The provision of a redundant energy supply for the front-axle brake modules is advantageous, in particular, in embodiments in which the front-axle brake modules also have a locking mechanism. The wheels of the front axle may be decelerated in such a way that the locking mechanism of the front axle can provide a corresponding parking-brake function.

According to a further preferred embodiment, the control module is a first control module, and the brake system also comprises a second control module, for monitoring the front-axle operating supply circuit in a first switching state. The second control module is configured to switch from a first switching state, in which the second energy storage unit supplies energy to the front-axle brake module via the front-axle operating supply circuit, to a second switching state. In the second switching state, the first energy storage unit supplies energy to the front-axle brake module via the rear-axle operating supply circuit and, in particular, is connected to it by the second control module. The second control module is also configured to monitor the operating state of the front-axle operating supply circuit and of the second energy storage unit in the first switching state, and to switch to the second switching state in the event of an operating-state fault. This provides a corresponding monitoring function and redundant energy supply and energy lead for both the front axle and the rear axle. The brake system therefore has a high degree of fail-safety.

In a second aspect, the present disclosure relates to a vehicle, in particular a commercial vehicle, which has a rear axle having two rear wheels, a front axle having two front wheels, and a brake system, according to the first aspect of the invention, for providing a service-brake function and a parking-brake function on the rear axle and/or the front axle.

The vehicle benefits from the same advantages as the brake system of the first aspect. The preferred embodiments of the first aspect are likewise preferred embodiments of the vehicle and vice versa, such that, in this regard, reference is made to what has been set out above, in order to avoid repetition.

In a third aspect, the present disclosure relates to a method for controlling an electromechanical brake system for a vehicle, in particular a commercial vehicle. In particular, the invention according to the third aspect relates to a method for controlling an electromechanical brake system according to the first aspect of the invention. The method includes the steps:
a) provision of a service-brake function and a parking-brake function by a brake module,
b) supplying of energy to the brake module by a first energy storage unit, which is connected to the brake module by means of an electrical operating supply circuit,
c) monitoring of the operating state of the electrical operating supply circuit and of the first energy storage unit in a first switching state,
d) switching from the first switching state to a second switching state in the event of an operating-state fault,
e) supplying of energy to the brake module by a second energy storage unit, which is connected to the brake module via a redundancy supply circuit, in the second switching state.

The method benefits from the same advantages as the brake system of the first aspect. The preferred embodiments of the first aspect are likewise preferred embodiments of the method and vice versa, such that, in this regard, reference is again made to what has been set out above, in order to avoid repetition.

According to a preferred embodiment, the method also includes one, more or all of the following steps:
f) dedicated monitoring of the operating state of the first energy storage unit in the first switching state,
g) electrically decoupling the operating supply circuit from the brake module in the second switching state,
h) electrically decoupling the operating supply circuit from a brake actuator in the second switching state,
i) connecting a brake actuator to the redundancy supply circuit in the second switching state,
j) controlling the brake module by means of at least one control unit,
k) supplying of energy to the control unit by the first energy storage unit, which is connected to the control unit by means of a dedicated supply lead.

The dedicated monitoring of the operating state of the first energy storage unit in the first switching state makes it possible to locate the fault. The control module is thus configured to distinguish between a fault in the operating state of the first energy storage unit and a fault in the operating state of the operating supply circuit. This is advantageous with regard to repair and servicing work. Electrically decoupling the operating supply circuit from the brake module, or the brake actuator, in the event of an operating-state fault, protects these from damage, for example caused by overvoltage. Connecting the brake actuator to the redundancy supply circuit in the second switching state ensures the operation of the brake actuator, and thus the provision of the service-brake function even in the event of a fault in the operating state of the operating supply circuit, or of the first energy storage unit. As a result of energy being supplied to the control unit by the first energy storage unit, it is possible to dispense with additional dedicated energy storage units for supplying the control unit. The monitoring of the operating supply circuit and of the first energy storage unit thus simultaneously serves to monitor a sufficient energy supply to the electrical control unit. As a result of the control unit being connected by means of a dedicated supply lead of the operating supply circuit, a fault in a supply lead for supplying the brake module does not simultaneously cause a fault in the energy supply of the control unit. Also because of the dedicated supply lead, the control unit may be arranged in a flexible manner on the brake system, thereby enabling available installation space to be utilized efficiently. This further increases the safety of the brake system.

Embodiments of the present disclosure are now described in the following with reference to the drawings. The latter is not necessarily intended to represent the embodiments to scale; rather, where useful for explanation, the drawings are in a schematized and/or slightly distorted form. With regard to additions to the teachings directly evident from the drawings, reference is made to the relevant prior art. It is to be taken into consideration that a variety of modifications and changes concerning the form and detail of an embodiment may be made without departing from the general idea of the present disclosure. The features of the present disclosure disclosed in the description, in the drawing, and/or in the claims may be essential for the development of the present disclosure, either individually or in any combination.

Moreover, all combinations of at least two of the features disclosed in the description, the drawing, and/or the claims fall within the scope of the present disclosure. The general idea of the present disclosure is not limited to the exact form or detail of the preferred embodiments shown and described in the following, or limited to a subject-matter that would be limited in comparison with the subject-matter claimed in the claims. In the case of specified dimensional ranges, values lying within the stated limits are also intended to be disclosed as limiting values, and to be such that they can be applied and claimed in any manner. For simplicity, the same reference designations are used in the following for parts that are identical or similar, or parts that have an identical or similar function.

### BRIEF DESCRIPTION OF THE DRAWINGS

Further advantages, features and details of the present disclosure are provided in the following description of the preferred embodiments, and on the basis of the drawings, in which:

FIG. 1 illustrates a vehicle according to a first embodiment;

FIG. 2 illustrates a vehicle according to a second embodiment;

FIG. 3 illustrates a vehicle according to a third embodiment;

FIG. 4 illustrates a vehicle according to a fourth embodiment;

FIG. 5 illustrates a vehicle according to a fifth embodiment;

FIG. 6 illustrates a method for operating a brake system according to a first embodiment;

FIG. 7 illustrates a method for operating a brake system according to a second embodiment, in the first switching state;

FIG. 8 illustrates the method according to FIG. 6, in a second switching state.

### DETAILED DESCRIPTION

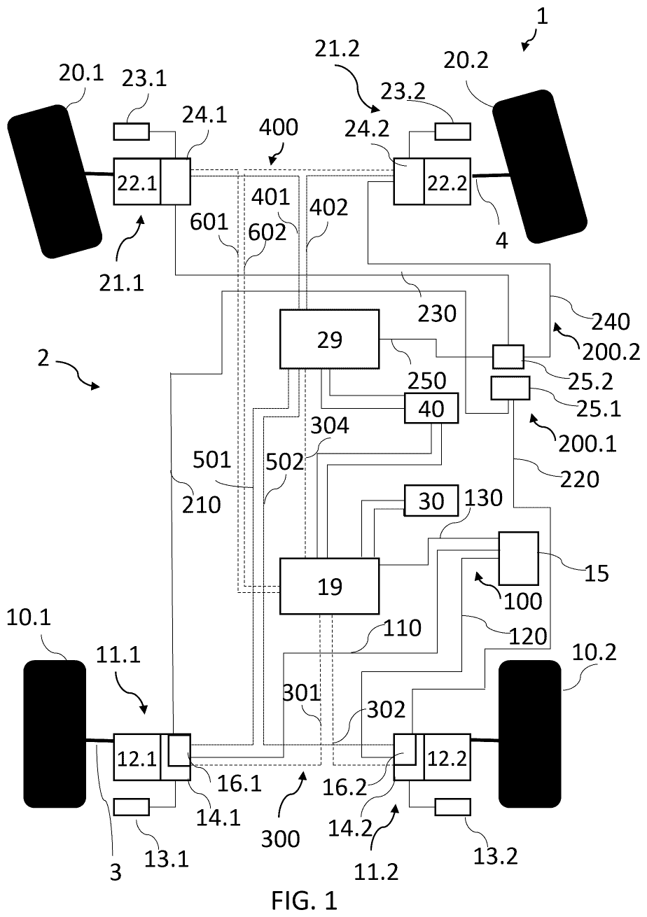

The brake system 2 as shown in FIG. 1 is part of a vehicle 1. The vehicle 1 also includes two rear wheels 10.1, 10.2 that are mounted at the ends of a rear axle 3 of the vehicle 1. The vehicle 1 also includes two front wheels 20.1, 20.2 that are mounted at the ends of a front axle 4.

The brake system 2 according to FIG. 1 includes a first electromechanical rear-axle brake module 11.1 and a second electromechanical rear-axle brake module 11.2. The first rear-axle brake module 11.1 is assigned to the first rear wheel 10.1. The first rear-axle brake module 11.1 includes a rear-axle brake actuator 12.1 and a first actuator controller 14.1 for controlling the first rear-axle brake actuator 12.1. Preferably, the first actuator controller 14.1 is connected to a rear-axle wheel rotational-speed sensor 13.1. The first rear-axle brake actuator 12.1 also has a locking mechanism that is configured to provide a parking-brake function by locking the rear-axle brake actuator 12.1. The second rear-axle brake module 11.2 is assigned to the second rear wheel 10.2. Corresponding to the first rear-axle brake module 11.1, the second rear-axle brake module 11.2 also includes a rear-axle brake actuator 12.2, preferably a rear-axle wheel rotational-speed sensor 13.2 and a second actuator controller 14.2. The rear-axle brake actuators 12.1, 12.2 may preferably also have a parking-brake actuator system.

The brake system 2 also includes a first energy storage unit 15, which is configured to supply energy to the first rear-axle brake module 11.1 and the second rear-axle brake module 11.2. An electrical operating supply circuit 100 is connected to the first energy storage unit 15. In the present case, the electrical operating supply circuit 100 is a rear-axle operating supply circuit for supplying the brake modules 11.1, 11.2 of the rear axle 3.

The energy storage unit 15 is a first energy storage unit, and the brake system 2 also includes a second energy storage unit 25.1 and an electrical redundancy supply circuit 200.1 connected to the second energy storage unit 25.1.

The brake system 2 also includes a control module connected to the operating supply circuit 100 and the redundancy supply circuit 200.1. In the embodiment shown, the control module includes two control modules 16.1, 16.2, which may also be realized by a combined control module. A first control module 16.1 is assigned to the first rear-axle brake module 11.1 and, in particular, is structurally integrated into it. The second control module 16.2 is assigned to the second rear-axle brake module 11.2 and, in particular, is structurally integrated into it. The control modules 16.1, 16.2 are each configured to switch from a first switching state, in which the first energy storage unit 15 supplies energy to the rear-axle brake modules 11.1, 11.2 via the operating supply circuit 100, to a second switching state. In the second switching state, the second energy storage unit 25.1 supplies energy to the rear axle brake modules 11.1, 11.2 via the redundancy supply circuit 200.1. The control modules 16.1, 16.2 are also configured to monitor the operation of the operating supply circuit 100 and of the first energy storage unit 15 in the first switching state, and to switch to the second switching state in the event of an operating-state fault.

The operating supply circuit 100 includes a first supply lead 110, for connecting the first energy storage unit 15 to the first rear-axle brake module 1 1.1. The operating supply circuit 100 also includes a second supply lead 120, for connecting the first energy storage unit 15 to the second rear-axle brake module 1 1.2.

Preferably, the operating supply circuit 100 also includes a dedicated supply lead 130, for supplying energy to a control unit 19 of the brake system 2, through the first energy storage unit 15. The control unit 19 is a first control unit that is assigned to the first rear-axle brake module 11.1 and the second rear-axle brake module 11.2. The control unit 19 is configured to control the first rear-axle brake module 11.1 and the second rear-axle brake module 11.2.

The redundancy supply circuit 200.1 includes a first redundancy supply lead 210, for connecting the first energy storage unit 15 to the first rear-axle brake module 11.1. The redundancy supply circuit 200.1 also includes a second redundancy supply lead 220, for connecting the first energy storage unit 15 to the second rear-axle brake module 11.2.

Preferably, the brake system 2 also has a first front-axle brake module 21.1 and a second front-axle brake module 21.2.

The first front-axle brake module 21.2 includes a front-axle brake actuator 22.1 and a first actuator controller 24.1 for controlling the first front-axle brake actuator 22.1. The first front-axle brake module 21.1 is assigned to the first front wheel 20.1. Preferably, the first actuator controller 24.1 is connected to a front-axle wheel rotational-speed sensor 23.1. The front-axle brake actuator 22.1 also has a locking mechanism configured to provide a parking-brake function by locking the front-axle-brake actuator 22.1. The second front-axle brake module 21.2 is assigned to the second front wheel 20.2. Corresponding to the first front-axle brake module 21.1, the second front-axle brake module 21.2 also includes a front-axle brake actuator 22.2, preferably a front-axle wheel rotational-speed sensor 23.2 and a second actuator controller 24.2. The front-axle brake actuators 22.1, 22.2 may preferably also have a parking-brake actuator system.

The brake system 2 also includes a third energy storage unit 25.2, which is configured to supply energy to the first front-axle brake module 21.1 and the second front-axle brake module 21.2. A second electrical operating supply circuit 200.2 is connected to the second energy storage unit 25.2. In the present case, the second electrical operating supply circuit 200.2 is a front-axle operating supply circuit for supplying the brake modules 21.2, 21.2 of the front axle 4.

The first control unit 19 is connected to the rear-axle brake modules 11.1, 11.2 via a first control circuit 300. For connection to the first rear-axle brake module 11.1, the first control circuit 300 has a first control lead 301. For connection to the second rear-axle brake module 11.2, the control circuit 300 has a second control lead 302. The control circuit 300 also has a control connection lead 304, via which the first control unit 19 for the rear axle is connected to a second control unit 29.

The second control unit 29 is assigned to the first front-axle brake module 21.1 and to the second front-axle brake module 21.2. The second control unit 29 is configured to control the first front-axle brake module 21.1 and the second front-axle brake module 21.2. The second control unit 29 is connected to the front-axle brake modules 21.1, 21.2 via a second control circuit 400.

The control unit 19 for the rear axle 3 is connected to a parking-brake controller 30. The parking-brake controller 30 is configured to provide a control signal for locking the brake actuator 12.1, 12.2 in order to provide a parking-brake function.

The brake system 2 also includes an actuating element 40 that, in respect of control, is connected to the first control unit 19 and the second control unit 29. The actuating element 40 is configured to indicate a call for braking. The control units 19, 29 are configured to provide corresponding brake signals to the brake modules 11.1, 11.2, 21.1, 21.2, via the control circuits 300, 400, on the basis of this call for braking.

Preferably, the second control unit 29 is configured to provide a redundant control connection to the rear-axle brake modules 11.1, 11.2 via a third control circuit 500. Owing to this control connection via the control leads 501, 502, the second control unit 29 is configured to control the rear-axle brake modules 11.1, 11.2. Thus, in the event of a failure of the first energy storage unit 15, control of the brake modules 11.1, 11.2 can also still be maintained by the second control unit 29.

Preferably, the first control unit 19 is configured to provide a redundant control connection to the front-axle brake modules 21.1, 21.2 via a fourth control circuit 600. Owing to this control connection via the control leads 601, 602, the first control unit 19 is configured to control the front-axle brake modules 21.1, 21.2. Thus, in the event of a failure of the second energy storage unit 25.1, control of the brake modules 21.1, 21.2 can also still be maintained by the first control unit 19.

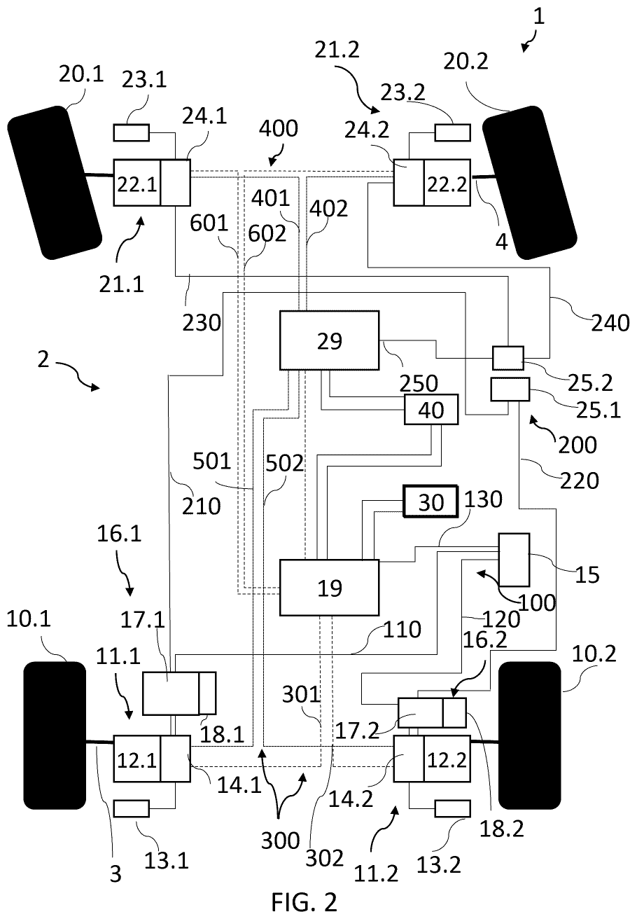

FIG. 2 shows a second embodiment of a brake system 2 according to the present disclosure. The brake system 2 according to FIG. 2 differs only in the design and arrangement of the first control module 16.1 and the second control module 16.2. To avoid repetition, reference is therefore made to the detailed description of the brake system 2 according to the exemplary embodiment shown in FIG. 1. Here, components that are the same, or similar, are denoted by the same reference designations.

The first control module 16.1 is realized as a dedicated control module with respect to the first rear-axle brake module 11.1 and is arranged at a distance from the first rear-axle brake module 11.1. The second control module 16.2 is likewise realized as a dedicated control module with respect to the second rear-axle brake module 11.2 and is arranged at a distance from the latter. Both control modules 16.1, 16.2 are arranged close to the corresponding rear-axle brake modules 11.1, 11.2.

It is to be understood that it is also possible for only one control module to be provided for the first rear-axle brake module 11.1 and the second rear-axle brake module 11.2.

In the embodiment shown, the first control module 16.1 includes a first switch-over unit 17.1, which is configured to switch between the first switching state and the second switching state. The first control module 16.1 also includes a first monitoring unit 18.1, which is configured to monitor the operating supply circuit 15.

The second control module 16.2 correspondingly includes a second switch-over unit 17.2 and a second monitoring unit 18.2.

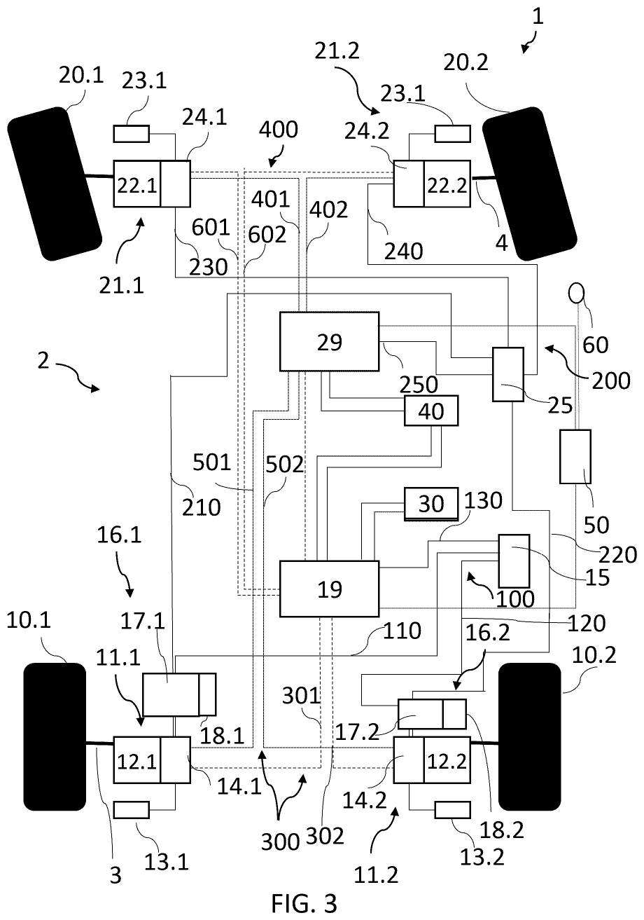

FIG. 3 shows a third embodiment of a brake system 2 according to the present disclosure. The brake system 2 according to FIG. 3 differs from the brake system shown above in FIG. 2 in the design of the redundancy supply circuit 200. To avoid repetition, reference is therefore made to the detailed description of the brake system 2 according to the exemplary embodiment shown in FIG. 2. Here, components that are the same, or similar, are denoted by the same reference designations.

The redundancy supply circuit 200 is a front-axle operating supply circuit 200 assigned to the front axle 4 and its brake modules 21.1, 21.2. The redundancy supply circuit 200, or front-axle operating supply circuit 200, is configured to provide both a redundant energy supply for the rear-axle brake modules 11.1, 11.2 by connection to the second energy storage unit 25, and a connection of the front-axle brake modules 21.1, 21.2 to the second energy storage unit 25. It is thus possible to dispense with a third energy source, as provided in the exemplary embodiment in FIG. 2.

The brake system 2 shown in FIG. 3 also differs from the brake system shown above in FIG. 2 in that it has a CAN-bus connection 50 for connecting, in respect of control, the first control unit 19 and the second control unit 29 to a central control unit of the vehicle 1. The CAN-bus connection 50 also establishes, for example, a connection between a steering-angle sensor 60 and the control units 19, 29.

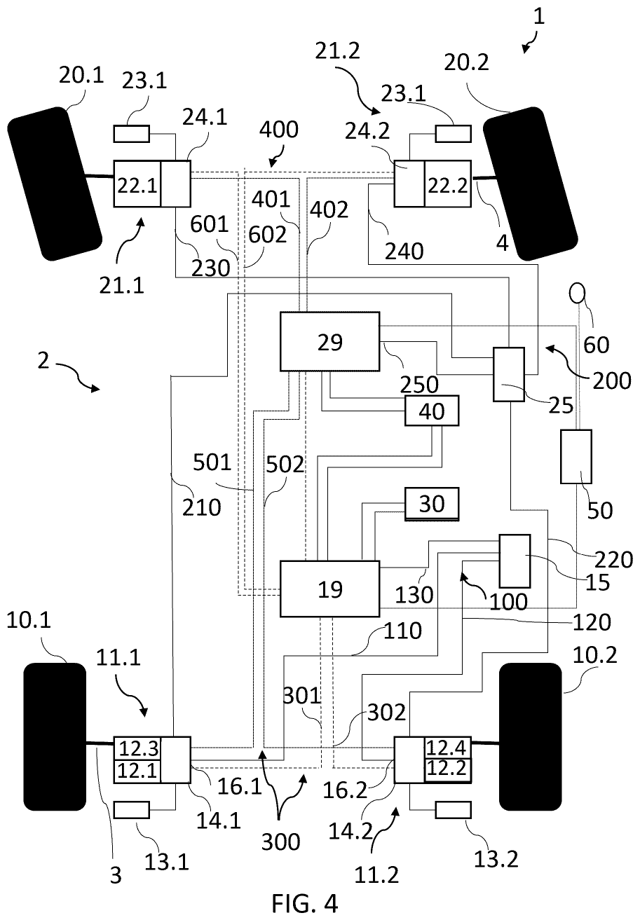

FIG. 4 shows a fourth embodiment of a brake system 2 according to the present disclosure. The brake system 2 according to FIG. 4 differs from the brake system shown above in FIG. 1 in the design of the rear axle brake modules 11.1, 11.2. To avoid repetition, reference is therefore made to the detailed description of the brake system 2 according to the exemplary embodiment shown in FIG. 1. Here, components that are the same, or similar, are denoted by the same reference numbers.

The first rear-axle brake module 11.1 has a first rear-axle brake actuator 12.1 that is connected to the first energy storage unit 15 via the operating supply circuit 100 and, in particular, its first supply lead 110. The second rear-axle brake module 11.2 has a second rear-axle brake actuator 12.2 that is connected to the first energy storage unit 15 via a second supply lead 120 of the first operating supply circuit 100.

The first rear-axle brake module 11.1 also includes a third rear-axle brake actuator 12.3 that is configured to provide a service-brake function in the second switching position. The third rear-axle brake actuator 12.3 is connected to the second energy storage unit 25 via a first redundancy supply lead 210 of the redundancy supply circuit 200.

The second rear-axle brake module 11.2 also has a fourth rear-axle brake actuator 12.4, for providing a service-brake function in the second switching position. The fourth rear-axle brake actuator 12.4 is connected to the second energy storage unit 25 via a second redundancy supply lead 220 of the redundancy supply circuit 200.

Alternatively, the third and the fourth rear-axle brake actuator 12.3, 12.4 may each be equipped with their own redundant actuator controller, energy then being supplied to these, from the second energy storage unit 25, by the redundancy supply circuit 200.

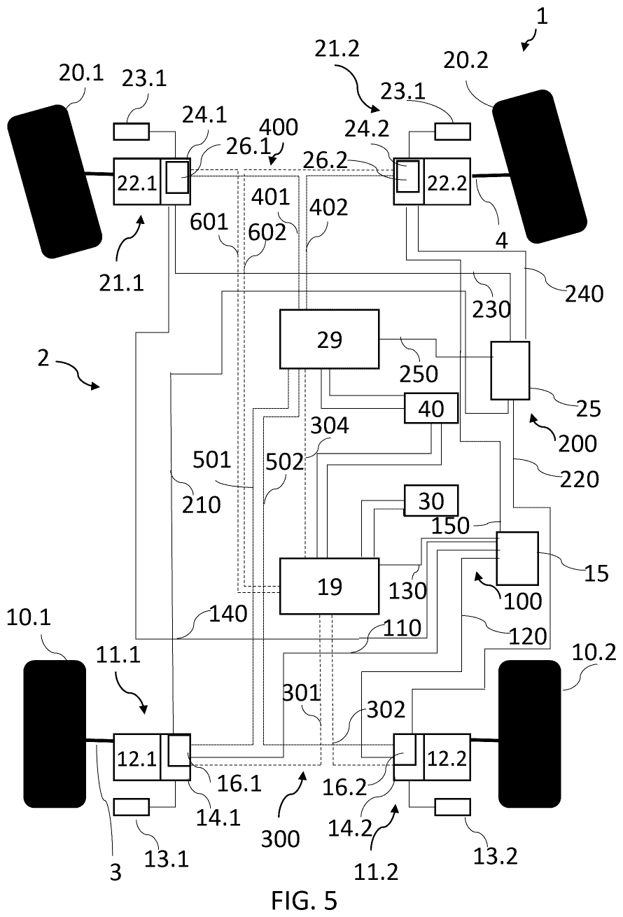

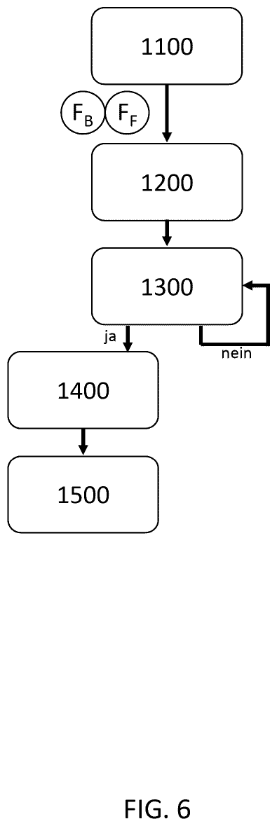

The method 1000 shown in FIG. 6 for controlling an electromechanical parking-brake system 2 (see FIGS. 1 to 5) includes, in a first step 1100, provision of a service-brake function FB and a parking-brake function FF by a brake module 11.1, 11.2, 21.1, 21.2 (see FIGS. 1 to 5). In a second step 1200, the method 1000 includes supplying of energy to the brake module 11.1, 11.2, 21.1, 21.2 (see FIGS. 1 to 5) by a first energy storage unit 15 (see FIGS. 1 to 5), which is connected to the brake module 11.1, 11.2, 21.1, 21.2 (see FIGS. 1 to 5) by means of an electrical operating supply circuit 100. The method also includes, in a third step 1300, monitoring of the operating state of the electrical operating supply circuit 100 and of the first energy storage unit 15 by a control module 16.1, 16.2, 26.1, 26.2 (see FIGS. 1 to 5) in a first switching state of the control module.

When the control module 16.1, 16.2, 26.1, 26.2 (see FIGS. 1 to 5) recognizes an operating-state fault, it switches, in a fourth step 1400, from the first switching state to a second switching state. In this second switching state, in a fifth step 1500, a second energy storage unit 25, which is connected to the brake module 11.1, 11.2, 21.1, 21.2 via a redundancy supply circuit 200, supplies energy to the brake module 11.1, 11.2, 21.1, 21.2 (see FIGS. 1 to 5).

In the absence of an operating-state fault, the control module 16.1, 16.2, 26.1, 26.2 (see FIGS. 1 to 5), in a sixth step 1600, maintains the connection of the first energy storage unit 15 (see FIGS. 1 to 5) via the operating supply circuit 100 (see FIGS. 1 to 5).

In the absence of an operating-state fault, the third step 1300 is repeated until an operating-state fault is sensed.

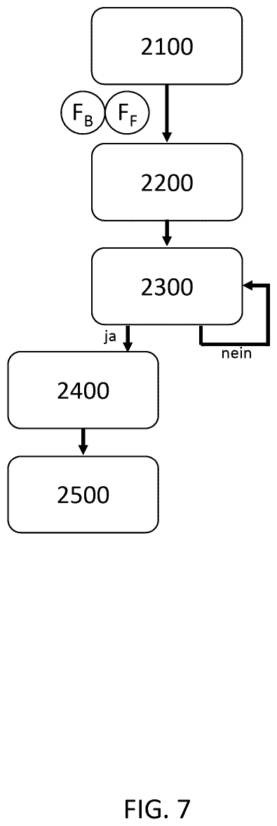

FIG. 7 shows a second exemplary embodiment of the method 2000 for controlling an electromechanical brake system 2 (see FIGS. 1 to 5). The method 2000 includes, in a first step 2100, provision of a service-brake function FB and a parking-brake function FF by a brake module 11.1, 11.2, 21.1, 21.2 (see FIGS. 1 to 5). In a second step 2200, the method 2000 includes supplying of energy to the brake module 11.1, 11.2, 21.1, 21.2 by a first energy storage unit 15 (see FIGS. 1 to 5), which is connected to the brake module 11.1, 11.2, 21.1, 21.2 (see FIGS. 1 to 5) by means of an electrical operating supply circuit 100. The method also includes, in a third step 2300, dedicated monitoring of the operating state of the electrical operating supply circuit 100 and of the energy storage unit 15 by a control module 16.1, 16.2, 26.1, 26.2 (see FIGS. 1 to 5) in a first switching state of the control module 16.1, 16.2, 26.1, 26.2 (see FIGS. 1 to 5).

When the control module 16.1, 16.2, 26.1, 26.2 (see FIGS. 1 to 5) recognizes an operating-state fault, it switches, in a fourth step 2400, from the first switching state to a second switching state. The switching of the control module 16.1, 16.2, 26.1, 26.2 (see FIGS. 1 to 5) to the second switching state includes the connecting of a brake actuator 12 of the brake module 11.1, 11.2, 21.1, 21.2 (see FIGS. 1 to 5) to the redundancy supply circuit 200.

In this second switching state, in a fifth step 2500, a second energy storage unit 25, which is connected to the brake module 11.1, 11.2, 21.1, 21.2 (see FIGS. 1 to 5) via a redundancy supply circuit 200, supplies energy to the brake module.

In the absence of an operating-state fault, the third step 2300 is repeated until an operating-state fault is sensed.

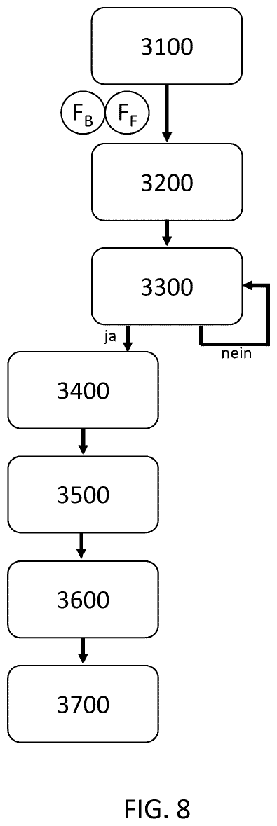

FIG. 8 shows a third exemplary embodiment of the method 3000 for controlling an electromechanical brake system 2 (see FIGS. 1 to 5). The method 3000 includes, in a first step 3100, provision of a service-brake function FB and a parking-brake function FF by a brake module 11.1, 11.2, 21.1, 21.2 (see FIGS. 1 to 5). In a second step 3200, the method 3000 includes supplying of energy to the brake module 11.1, 11.2, 21.1, 21.2 (see FIGS. 1 to 5), the brake actuator 12 and a control unit 19 for the brake module 11.1, 11.2, 21.1, 21.2 (see FIGS. 1 to 5) by a first energy storage unit 15. The first energy storage unit 15 is connected to the brake module 11.1, 11.2, 21.1, 21.2 (see FIGS. 1 to 5) by way of an electrical operating supply circuit 100. The method also includes, in a third step 2300, monitoring of the operating state of the electrical operating supply circuit 100, the first energy storage unit 15 and the control unit 19 by a control module 16.1, 16.2, 26.1, 26.2 (see FIGS. 1 to 5) in a first switching state of the control module 16.1, 16.2, 26.1, 26.2 (see FIGS. 1 to 5). The control unit 19 is configured to control at least one brake actuator 11.1, 11.2, 21.1, 21.2 (see FIGS. 1 to 5), as described with reference to FIGS. 1 to 5.

When the control module 16.1, 16.2, 26.1, 26.2 (see FIGS. 1 to 5) recognizes an operating-state fault, it switches, in a fourth step 2400, from the first switching state to a second switching state. The switching of the control module 16.1, 16.2, 26.1, 26.2 (see FIGS. 1 to 5) to the second switching state includes the connecting of a brake actuator 12 of the brake module 11.1, 11.2, 21.1, 21.2 (see FIGS. 1 to 5) to the redundancy supply circuit 200.

In this second switching state, in a fifth step 3500, a second energy storage unit 25, which is connected to the brake module 11.1, 11.2, 21.1, 21.2 (see FIGS. 1 to 5) via a redundancy supply circuit 200, supplies energy to the brake module 11.1, 11.2, 21.1, 21.2 (see FIGS. 1 to 5).

In the absence of an operating-state fault, the third step 3300 is repeated until an operating-state fault is sensed.

The method 300 also includes, in a sixth step 3600, electrically decoupling the operating supply circuit 100 from the brake module 11.1, 11.2, 21.1, 21.2 (see FIGS. 1 to 5) in the second switching state. Preferably, the method 300 also includes, in the seventh step 3700, electrically decoupling the brake actuator 12 from the operating supply circuit 100.

### List of Reference Designations (Part of the Description)

1 vehicle
2 brake system
3 rear axle
4 front axle
10.1, 10.2 wheels
11.1, 11.2 electromechanical (rear-axle) brake module
12.1, 12.2, 12.3, 12.4 (rear-axle) brake actuator
13.1, 13.2 (rear-axle) wheel rotational-speed sensor
14.1, 14.2 actuator controller
15 first energy storage unit
16.1, 16.2 (rear-axle) control module
17.1, 17.2 (rear-axle) switch-over unit
18 (rear-axle) monitoring unit
19 (rear-axle) control unit
100 (rear-axle) operating supply circuit
110 first supply lead of the first electric operating circuit
120 second supply lead of the first electric operating circuit
130 dedicated supply lead of the first electric operating circuit
20.1, 20.2 wheels
21.1, 21.2 electromechanical (rear-axle) brake module
22.1, 22.2 (front-axle) brake actuator
23.1, 23.2 (front-axle) wheel rotational-speed sensor
24.1, 24.2 (front-axle) actuator controller
25, 25.1 second energy storage unit
25.2 third energy storage unit
26.1, 26.2 (front-axle) control module
27.1, 27.2 (front-axle) switch-over unit
28 (front-axle) monitoring unit
29 (front-axle) control unit
30 parking-brake controller
40 actuating element
50 CAN-bus connection
60 steering-angle sensor
200, 200.1 redundancy supply circuit
200.2 front-axle operating supply circuit
210 first redundancy supply lead
220 second redundancy supply lead
230 first supply lead of the second electric operating circuit/redundancy supply circuit
240 second supply lead of the second electric operating circuit/redundancy supply circuit
250 dedicated supply lead of the second electric operating circuit/redundancy supply circuit
300 first control circuit
301 first control lead of the first control circuit
302 second control lead of the first control circuit
304 control connection lead
400 second control circuit
401 first control lead of the second control circuit
402 second control lead of the second control circuit
500 third control circuit
501 first control lead of the third control circuit
502 second control lead of the third control circuit
600 fourth control circuit
601 first control lead of the fourth control circuit
602 second control lead of the fourth control circuit
1000, 2000, 3000 first step
1100, 2100, 3100 provision of a service-brake and parking-brake function
1200, 2200, 2300 supplying of energy by the operation supply circuit
1300, 2300, 3300 (dedicated) monitoring of the operation supply circuit
1400, 2400, 3400 switching from the first to the second operating state
1500, 2500, 3500 supplying of energy by the redundancy supply circuit
3600 electrically decoupling the brake module
3700 electrically decoupling the brake actuator
F_{F} parking-brake function
F_{B} service-brake function

1. A brake system (2) for a vehicle (1), commercial comprising:
an electromechanical brake module (11.1, 11.2) that provides a service-brake function (F_{B}) and a parking-brake function (F_{F}),
a first energy storage unit (15) that supplies energy to the brake module (11.1, 11.2), and
an electric operating supply circuit (100) that is connected to the first energy storage unit (15) and selectively connects the first energy storage unit (15) to the brake module (11.1, 11.2),
a second energy storage unit (25, 25.1) and an electrical redundancy supply circuit (200, 200.1) that is connected to the second energy storage unit, and
a control module (16.1, 16.2) that is connected to the operating supply circuit (100) and the redundancy supply circuit (200, 200.1), and that
wherein the control module (16.1, 16.2) is configured to switch from a first switching state, in which the first energy storage unit (15) supplies energy to the brake module (11.1, 11.2) via the operating supply circuit (100), to a second switching state, in which the second energy storage unit (25, 25.1) supplies energy to the brake module (11.1, 11.2) via the redundancy supply circuit (200, 200.1),
wherein the control module (16.1, 16.2) is also configured to monitor an operating state of the operating supply circuit (100) and of the first energy storage unit

(15) in the first switching state, and to switch to the second switching state in response to detecting an operating-state fault.

2. The brake system (2) as claimed in claim 1,
wherein the control module (16.1, 16.2) is configured, in the first switching state, to monitor, in a dedicated manner, the operating state of the first energy storage unit (15) and of the operating supply circuit (100).

3. The brake system (2) as claimed in claim 1,
wherein the control module (16.1, 16.2) is also configured to electrically decouple the operating supply circuit (100) from the brake module (11.1, 11.2) in response to detecting the operating-state fault.

4. The brake system (2) as claimed in claim 1,
wherein the control module (16.1, 16.2) is dedicated control module (16.1, 16.2) with respect to the brake module (11.1, 11.2), and is arranged at a distance from the brake module (11.1, 11.2), wherein the the control module (16.1, 16.2) is arranged close to the brake module (11.1, 11.2).

5. The brake system (2) as claimed in claim 1,
wherein the control module (16.1, 16.2) is integrated structurally into the brake module (11.1, 11.2).

6. The brake system (2) as claimed in claim 1,
wherein the control module (16.1, 16.2) has a switch-over unit (17.1, 17.2) that is configured to switch between the first switching state and the second switching state, and has a monitoring unit (18.1, 18.2) that is configured to monitor the operating supply circuit (100).

7. The brake system (2) as claimed in claim 6,
wherein the brake module (11.1) is a first brake module (11.1), and the brake system (2) also comprises a second brake module (11.2), and
wherein the switch-over unit (17.1) is a first switch-over unit (17.1) that is arranged close to the first brake module (11.1), and the control module (16.1, 16.2) also comprises a second switch-over unit (17.2), which is arranged close to the second brake module (11.2).

8. The brake system (2) as claimed in claim 7,
wherein the first brake module (11.1) and the second brake module (11.2) each have a brake actuator (12, 12.1, 12.2), for providing the service-brake function (FB), including a locking mechanism for locking the brake actuator (12, 12.1, 12.2), and
wherein the control module (16.1, 16.2) is configured to connect each brake actuator (12, 12.1, 12.2), in the second switching state, to the redundancy supply circuit (200, 200.1), and to decouple each brake actuator electrically from the operating supply circuit (100).

9. The brake system (2) as claimed in claim 1,
wherein the brake module (11.1, 11.2) comprises:
a first brake actuator (12.1, 12.2), which is configured to provide the service-brake function (F_{B}) in the first switching state,
a redundant brake actuator (12.3, 12.4), which is configured to provide the service-brake function (F_{B}) in the second switching state, wherein the redundant brake actuator (12.3, 12.4) is assigned to the redundancy supply circuit (200, 200.1) and is decoupled from the operating supply circuit (100), wherein the first brake actuator and the redundant brake actuator are, respectively, first windings and second windings of a coil of an electric motor, with the first windings connected to the operating supply circuit and the second windings connected to the redundancy supply circuit, and
at least one locking mechanism (12.1, 12.2, 12.3, 12.4) for locking the first brake actuator (12.1, 12.2) and/or the redundant brake actuator (12.3, 12.4).

10. The brake system (2) as claimed in claim 7,
wherein the operating supply circuit (100) is a rear-axle operating supply circuit (100), and the brake module (11.1, 11.2) is a rear-axle brake module (11.1, 11.2), and the brake system (2) also comprises a front axle (4) having at least one front-axle brake module (21.1, 21.2) and wherein the redundancy supply circuit (200) is a front-axle operating supply circuit (200) that is assigned to the front axle (4) and that is configured to connect the second energy storage unit (25) to the front-axle brake module (21.1, 11.2).

11. The brake system (2) as claimed in claim 10, further comprising:
an electrical control unit (19) for controlling the first brake module (11.1) and the second brake module (11.2), wherein the operating supply circuit (100) is configured to supply energy to the control unit (19) in the first switching state.

12. The brake system (2) as claimed in claim 11,
wherein the operating supply circuit (100) has a dedicated supply lead (130) that is configured to connect the first energy storage unit (15) to the first control unit (19), and wherein the control module (16.1, 16.2) is also configured to monitor an operating state of the dedicated supply lead in the first switching state.

13. The brake system (2) as claimed in claim 11, further comprising:
a second electrical control unit (29), for controlling the front-axle brake module (21.1, 21.2), which is further configured to control the rear-axle brake module (11.1, 11.2) in the second switching state.

14. The brake system (2) as claimed in claim 13,
wherein the rear-axle operating supply circuit (100) is a second redundancy supply circuit (100) for the at least one front-axle brake module (21.1, 21.2) of the front axle (4).

15. The brake system (2) as claimed in claim 14,
wherein the control module (16.1, 16.2) is a first control module (16.1, 16.2), and the brake system (2) also comprises a second control module (26.1, 26.2), for monitoring the front-axle operating supply circuit (200, 200.2) and which is configured to switch from a first switching state, in which the second energy storage unit (25, 25.1) supplies energy to the front-axle brake module (21.1, 21.2) via the front-axle operating supply circuit (200, 200.2), to a second switching state, in which the first energy storage unit (15) supplies energy to the front-axle brake module (21.1, 21.2) via the rear-axle operating supply circuit (100), wherein the second control module (26.1 26.2) is also configured to monitor an the operating state of the front-axle operating supply circuit (200, 200.2) and of the second energy storage unit (25, 25.1) in the first switching state, and to switch to the second switching state in response to detecting an operating-state fault.

16. A vehicle (1) comprising:
a rear axle (3) having two rear wheels (10.1, 10.2),
a front axle (4) having two front wheels (20.1, 20.2), and
the brake system (2) as claimed in claim 1, for providing a service-brake function (F_{B}) and a parking-brake function (F_{F}) on the rear axle (3) and/or the front axle (4).

17. A method for controlling an electromechanical brake system (2) for a vehicle (1), comprising the steps:
providing a service-brake function (F_{B}) and a parking-brake function (F_{F}) by a brake module (11.1, 11.2, 21),
supplying (1200) energy to the brake module (11.1, 11.2 ) by a first energy storage unit (15), which is connected to the brake module (11.1, 11.2) by an electrical operating supply circuit (100),
monitoring (1300), via a control module, an operating state of the electrical operating supply circuit (100) and of the first energy storage unit (15) in a first switching state,
switching (1400), via the control module, from the first switching state to a second switching state in response to detecting an operating-state fault,
supplying (1500) of energy to the brake module (11.1, 11.2) by a second energy storage unit (25, 25.1), which is connected to the brake module (11.1, 11.2) via a redundancy supply circuit (200), in a second switching state.

18. The method as claimed in claim 17, further comprising at least of one of:
monitoring (1300), via the control module, which is dedicated with respect to the brake module, an operating state of the first energy storage unit (15) in the first switching state,
electrically decoupling (1700) the operating supply circuit (100) from the brake module (11.1, 11.2) in the second switching state,
electrically decoupling (1700) the operating supply circuit (100) from a brake actuator (12.1, 12.2) in the second switching state, for the purpose of providing a service-brake function,
connecting a brake actuator to the redundancy supply circuit (200) in the second switching state,
controlling the brake module (11.1, 11.2) by at least one control unit (19, 29),
supplying (1200) of energy to the control unit (19) by the first energy storage unit (15), which is connected to the control unit (19) by a dedicated supply lead,
monitoring (1300) an operating state of the control unit (19) and of the dedicated supply lead in the first switching state.

19. The brake system (2) as claimed in claim 1,
wherein the control module (16.1, 16.2) is integrated in respect of control into the brake module (11.1, 11.2).

20. The brake system (2) as claimed in claim 1,
wherein the brake module (11.1, 11.2) has a brake actuator (12, 12.1, 12.2), for providing the service-brake function (F_{B}), including a locking mechanism for locking the brake actuator (12, 12.1, 12.2), and
wherein the control module (16.1, 16.2) is configured to connect the brake actuator (12, 12.1, 12.2), in the second switching state, to the redundancy supply circuit (200, 200.1), and to decouple the brake actuator electrically from the operating supply circuit (100).
